(19) United States
(12) Patent Application Publication
(10) Pub. No.: US 2010/0005934 A1
(43) Pub. Date: Jan. 14, 2010

(54) Telescopic wrench

(76) Inventor: Jean-Jacques Guilbault, St-Germain (CA)

Correspondence Address: INVENTION QUEBEC INC., Suite 202, 8055, Boul. Viau, Montreal, QC, H1R 2T2, CA

(21) Appl. No.: 12/216,858

(22) Filed: Jul. 11, 2008

(51) Int. Cl. B25B 23/16; B25F 1/00

(52) U.S. Cl. 81/177.2; 81/437

(57) ABSTRACT

A wrench. The wrench is usable with a screwdriver head. The screwdriver head defines a screwdriver head effective portion and a screwdriver head attachment portion. The wrench includes a substantially elongated telescopic handle. The telescopic handle defines a handle first end and a substantially longitudinally opposed handle second end. The telescopic handle is configurable between a retracted configuration and an extended configuration. The handle first and second ends are closer to each other in the retracted configuration than in the extended configuration. The telescopic handle defines a handle first recess extending substantially longitudinally into the telescopic handle into the telescopic handle from the handle first end towards the handle second end and a handle second recess extending substantially longitudinally into the telescopic handle from the handle second end towards the handle first end. The handle first recess is configured and sized for slidably receiving the screwdriver head attachment portion thereinto. The wrench further includes a wrench head. The wrench head defines a wrench head effective portion and a wrench head attachment portion. The wrench head attachment portion is slidable into the handle second recess.

### FIELD OF THE INVENTION

The present invention relates generally to tools and, more particularly, to a telescopic wrench.

### BACKGROUND

In many occurrences, there is a need for an intended user to use a wrench to unscrew a relatively tight nut. For example, this is the case with car wheels for which a user may need to change a wheel having a flat tire using a hand wrench on the roadside, while the lug nuts holding the wheel were previously tightened using pneumatic tools. Indeed, to reduce the risk that the lug nuts become unscrewed from the wheels, which may lead to an accident, mechanics typically tighten these lug nuts with a relatively large torque using pneumatic tools. While using a wrench having a relatively long handle would provide the required torque, storage of such wrenches in a car is relatively inconvenient.

Furthermore, there is often a need, when performing a change of wheel to remove a wheel cover to access the lug nuts. Since these wheel covers are relatively weakly attached to the wheels, the tools used for such purposes are relatively small and, therefore, risk of being relatively easily dropped on the roadside, where they can be relatively difficult to retrieve thereafter, especially at night.

There are many existing wrenches having telescopic handles. For example, U.S. Pat. No. 510,981 issued Dec. 19, 1893 to Massey describes a combination tool having a relatively elongated handle into which a wrench head is insertable. The wrench head has a relatively long shaft that is slidably receivable by an elongated passageway formed into the handle. Due to the configuration of the relatively long shaft, the wrench head includes a relatively large amount of material. If there is a need to have wrench heads having different dimensions so as to be able to screw and unscrew nuts having different dimensions, the combination tool described in Massey would require a relatively large amount of material to manufacture, which may render the wrench relatively cumbersome to handle and relatively expensive to manufacture. In addition, since the tool described in Massey is only in two sections, the factor by which the tool described in this document can be expanded is relatively small, more specifically by less than a factor of 2.

Against this background, there exist a need for a new and improved wrench that avoids the aforementioned disadvantages. It is a general object of the present invention to provide a new and improved wrench.

### SUMMARY OF THE INVENTION

In a broad aspect, the invention provides a wrench. The wrench is usable with a screwdriver head. The screwdriver head defines a screwdriver head effective portion and a screwdriver head attachment portion. The wrench includes a substantially elongated telescopic handle. The telescopic handle defines a handle first end and a substantially longitudinally opposed handle second end. The telescopic handle is configurable between a retracted configuration and an extended configuration. The handle first and second ends are closer to each other in the retracted configuration than in the extended configuration. The telescopic handle defines a handle first recess extending substantially longitudinally into the telescopic handle from the handle first end towards the handle second end and a handle second recess extending substantially longitudinally into the telescopic handle from the handle second end towards the handle first end. The handle first recess is configured and sized for slidably receiving the screwdriver head attachment portion thereinto. The wrench further includes a wrench head. The wrench head defines a wrench head effective portion and a wrench head attachment portion. The wrench head attachment portion is slidable into the handle second recess.

In some embodiments of the invention, the handle first and second recesses are joined to each other through a handle passageway extending substantially longitudinally into the telescopic handle. Therefore, the handle passageway, the handle first recess and the handle second recess together form a single passageway. However, in alternative embodiments of the invention, the handle first and second recesses are provided with a bottom wall to form handle first and second recesses that are separated from the remainder of the remainder of the telescopic handle.

In some embodiments of the invention, the proposed wrench includes a screwdriver head lock and a wrench lock for selectively locking respectively the screwdriver head and the wrench head into the first and second recesses. Also, in some embodiments of the invention, the telescopic handle includes at least three members mounted to each other so as to be substantially longitudinally slidably movable relatively to each other.

The proposed wrench is therefore extensible over relatively large range of dimensions. This facilitates storage of the wrench when the wrench is in the retracted configuration and increases the torque that is applicable using the wrench when the wrench is in the extended configuration.

The proposed wrench is manufacturable using known materials and techniques so as to manufacture a relatively strong and durable tool at relatively small costs.

In some embodiments, the proposed telescopic handle has a substantially square cross-sectional configuration. This allows for the use of a wrench head having a wrench head attachment portion having a substantially square transversal cross-sectional configuration, which therefore minimizes the torque that must be supported by any component locking the wrench head to the telescopic handle, as opposed to the case in which the telescopic handle would have a round cross-sectional configuration as any torque exerted about a longitudinal axis of the telescopic handle is transmitted to the telescopic handle through this component.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in a perspective view, illustrates a wrench in accordance with an embodiment of the present invention, the wrench being shown in a retracted configuration;

FIG. 2, in a bottom plan view, illustrates the wrench shown in FIG. 1, the wrench being shown in the retracted configuration;

FIG. 3, in a side elevation view, illustrates the wrench shown in FIGS. 1 and 2, the wrench being shown in the retracted configuration;

FIG. 4, in a perspective view, illustrates the wrench shown in FIGS. 1 to 3, the wrench being shown in an extended configuration;

FIG. 5, in bottom plan view, illustrates the wrench shown in FIGS. 1 to 4, the wrench being shown in the extended configuration;

FIG. 6, in a side elevation view, illustrates the wrench shown in FIGS. 1 to 5, the wrench being shown in the extended configuration;

FIG. 7, in a perspective exploded view, illustrates the wrench shown in FIGS. 1 to 6;

FIG. 8, in a partial perspective exploded view, illustrates the wrench shown in FIGS. 1 to 7; and

FIG. 9, in a perspective view, illustrates a wrench head of the wrench shown in FIGS. 1 to 8.

### DETAILED DESCRIPTION

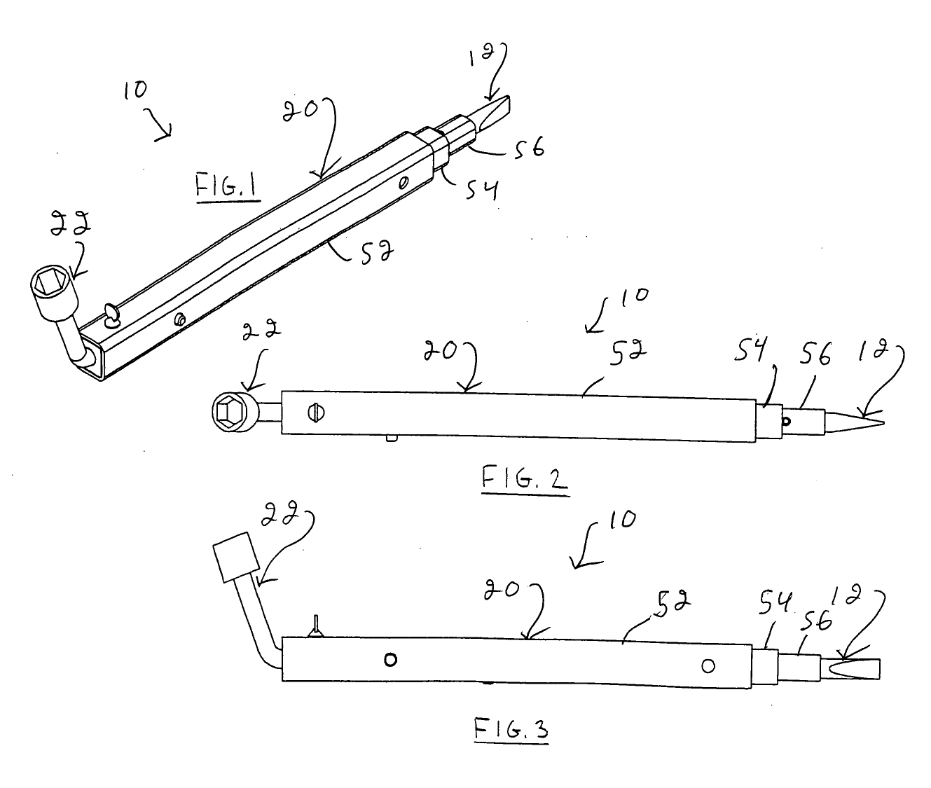

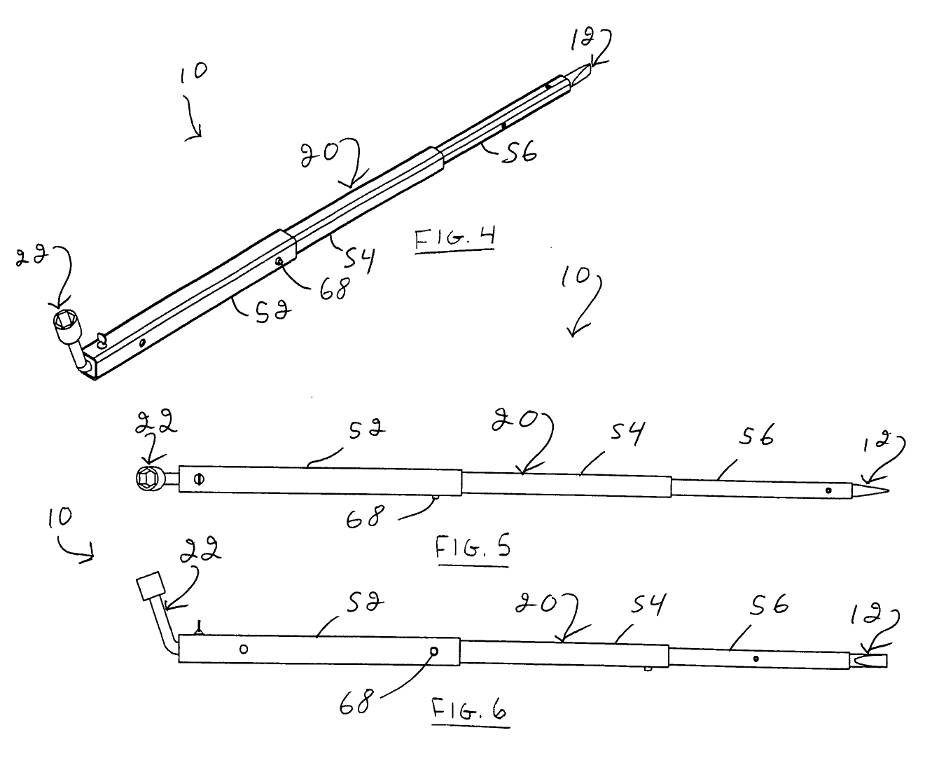

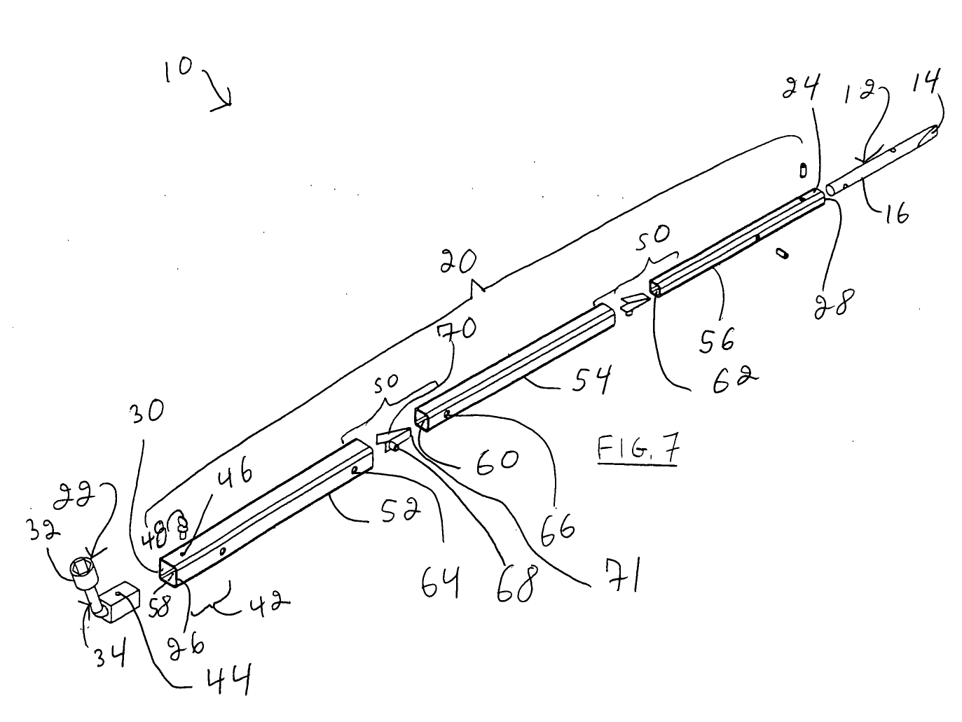

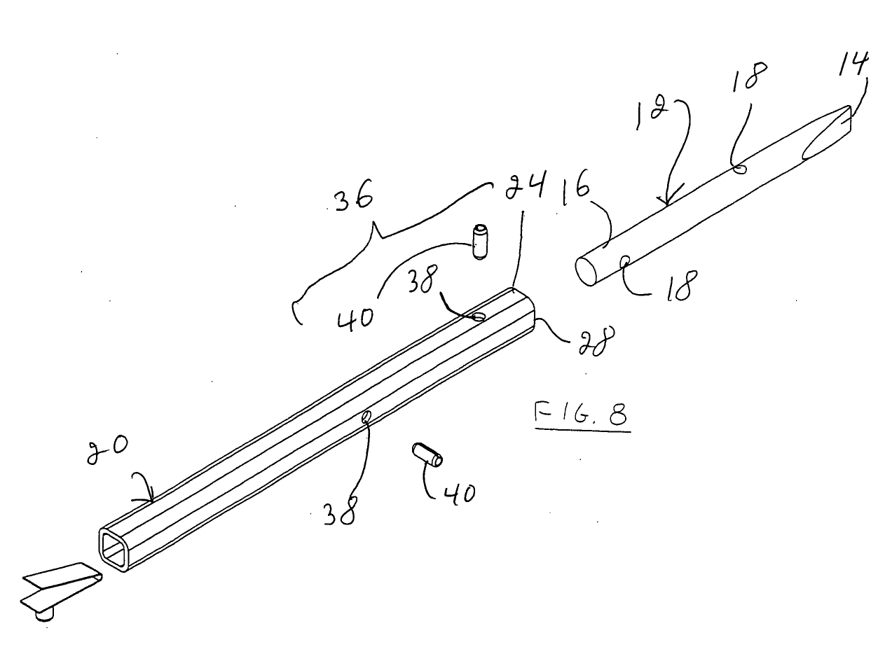

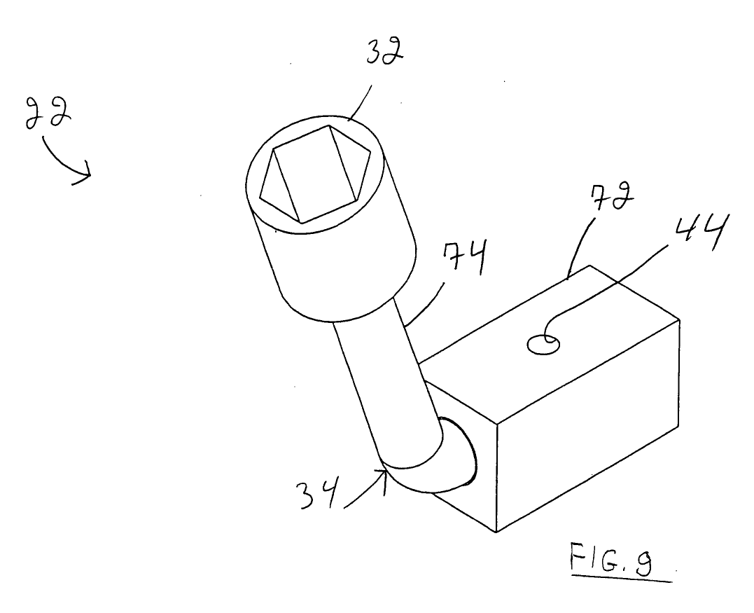

FIGS. 1 to 7 illustrate a wrench 10 in accordance with an embodiment of the present invention. The wrench 10 is usable with a screwdriver head 12. As seen for example in FIG. 8, the screwdriver head 12 defines a screwdriver head effective portion 14 usable for engaging a screw (not shown in the drawings) and a screwdriver head attachment portion 16, which typically has a substantially cylindrical configuration. The screwdriver head 12 further defines a screwdriver head locking aperture 18, typically in the form of a screwdriver head locking aperture 18 extending substantially radially inwardly into the screwdriver head attachment portion 16. Returning to FIGS. 1 to 6, the wrench 10 includes a substantially elongated telescopic handle 20 and a wrench head 22 removably attachable to the telescopic handle 20, as described in further details hereinbelow.

Referring to FIG. 7, the telescopic handle 20 defines a handle first end 24 and a substantially longitudinally opposed handle second end 26. The telescopic handle 20 is configurable between a retracted configuration, shown in FIGS. 1 to 3, and an extended configuration, shown in FIGS. 4 to 6. The handle first and second ends 24 and 26 are closer to each other in the retracted configuration than in the extended configuration.

Referring to FIG. 7, the telescopic handle 20 defines a handle first recess 28 (not visible explicitly in the drawings) extending substantially longitudinally into the telescopic handle 20 from the handle first end 24 towards the handle second end 26. A handle second recess 30 extends substantially longitudinally into the telescopic handle 20 from the handle second end 26 towards the handle first end 24. The handle first recess 28 is configured and sized for slidably receiving the screwdriver head attachment portion 16 thereinto.

The wrench head 22 defines a wrench head effective portion 32 and a wrench head attachment portion 34. The wrench head effective portion 32 is configured and sized so as to be usable for engaging a nut, typically a hexagonal lug nut (not shown in the drawings). When the wrench head effective portion 32 engages the nut, the nut is substantially snugly received by the wrench head effective portion 32 so as to allow rotation of the lug nut relative to threads onto which the lug nut is screwed. The wrench head attachment portion 34 is slidable into the handle second recess 30.

As seen in FIG. 8, the wrench 10 further includes a screwdriver head lock 36 for selectively locking the screwdriver head 12 into the handle first recess 28. The screwdriver head lock 36 includes a screwdriver head lock aperture 38 extending substantially radially inwardly into the telescopic handle 20, more specifically into the handle first recess 28. The screwdriver head lock aperture 38 is located such that the screwdriver head locking aperture 18 is positionable substantially in register with the screwdriver head lock aperture 38. A screwdriver head lock pin 40 is slidably insertable into the screwdriver head locking aperture 18 and through the screwdriver head lock aperture 38 when the screwdriver head locking aperture 18 and the screwdriver head lock aperture 38 are substantially in register with each other. When the screwdriver head lock pin 40 engages both the screwdriver head locking aperture 18 and the screwdriver head lock aperture 38, the screwdriver head 12 is locked to the telescopic handle 20. In some embodiments of the invention, two screwdriver head locking apertures 18 and two screwdriver head lock apertures 38 are provided so that the screwdriver head 12 is locked by two pins 90 to the telescopic handle 20. For example, the two screwdriver head lock apertures 38 are substantially longitudinally spaced apart and circumferentially spaced apart by about 90 degrees relative to each other

Referring to FIG. 7, the wrench 10 also includes a wrench head lock 42 for selectively locking the wrench head 22 into the handle second recess 30. To that effect, the wrench head attachment portion 34 defines a wrench head locking aperture 44 extending substantially radially inwardly thereinto. The wrench head lock 42 includes a wrench head lock aperture 46 extending substantially radially inwardly into the telescopic handle 20. The wrench head lock aperture 46 is located such that the wrench head locking aperture 44 is positionable substantially in register with the wrench head lock aperture 46. Therefore, the wrench head lock aperture 46 extends into the handle second recess 30.

A wrench head lock pin 48 is slidably insertable through the wrench head locking aperture 44 and through the wrench head lock aperture 46 when the wrench head locking aperture 44 and the wrench head lock aperture 46 are substantially in register with each other. The wrench head lock pin 48 therefore locks the wrench head 22 to the telescopic handle 20 when the wrench head lock pin 48 is inserted both through the wrench head locking aperture 44 and the wrench head lock aperture 46. To unlock the wrench head 22 from the telescopic handle 20, the wrench head lock pin 48 is withdrawn from the wrench head locking aperture 44.

In some embodiments of the invention, the screwdriver head lock pin 40 and the wrench head lock pin 48 are both attached to the telescopic handle so substantially radial slidable movement relative thereto and include a respective spring (not seen in the drawings) for biasing the screwdriver head lock pin 40 and the wrench head lock pin 48 substantially radially inwardly.

The telescopic handle 20 typically has a substantially square cross-sectional configuration. This configuration provides relatively large strength and facilitates coupling of the many members making up telescopic handle 20 to each other so as to prevent their relative rotation about the longitudinal axis of the telescopic handle 20.

Referring to FIG. 7, the telescopic handle 20 typically includes at least three members, namely handle first, second and third members 52, 54 and 56 operatively coupled to each other so as to be slidable longitudinally relative to each other. However, in alternative embodiments of the invention, any other suitable number of handle members is used. To that effect, the handle first, second and third members 52, 54 and 56 are substantially tubular and define respectively first, second and third member passageways 58, 60 and 62 extending substantially longitudinally therethrough. The handle second member 54 is slidably mounted inside the first member passageway 58 and the handle third member 56 is slidably mounted into the second member passageway 60. The handle first member 52 extends from the handle second end 24 and defines the handle second recess 30. The handle third member 56 defines the handle first recess 28.

The telescopic handle 20 includes a handle lock 50 for selectively locking the telescopic handle 20 in the extended configuration. The configuration of the handle lock 50 will be described more specifically with reference to the handle first and second members 52 and 54, with the understanding that similar components are used to lock the handle second and third members 54 and 56 to each other in the extended configuration. A first member aperture 64 extends substantially radially inwardly through the handle first member 52. Typically, the first member aperture 64 is longitudinally located substantially opposed to the handle first recess 28.

A second member aperture 66 extends substantially radially through the handle second member 54. The second member aperture 66 is located substantially longitudinally opposed to the handle third member 56 when the telescopic handle 20 is in the extended configuration. The handle first and second members 52 and 54 are located, configured and sized so that the first and second member apertures 64 and 66 are substantially in register with each other when the telescopic handle 20 is in the extended configuration.

A pin 68 is mounted to the handle first and second members 52 and 54 so as to be slidably movable through the first and second member apertures 64 and 66 when the first and second member apertures 64 and 66 are substantially in register with each other. The pin 68 is movable between a locked position in which the pin 68 extends through both the first and second member apertures 64 and 66 and an unlocked position in which the pin engages at most one of the first and second member apertures 64 and 66. When the pin 68 is in the locked position, relative movement along the longitudinal axis between the handle first and second members 52 and 54 is prevented by the pin 68. When the pin 68 is in the unlocked position, such movement is allowed so as to allow longitudinal movements of the handle first and second members 52 and 54 relative to each other.

Typically, a biasing element 70 is operatively coupled to the pin 68 for biasing the pin 68 towards the locked position. For example, as better seen in FIG. 8, the biasing element 70 includes a V-shaped resiliently deformable element from which the pin 68 extends integrally. The pin 68 extends substantially laterally outwardly at a location spaced apart from the apex 71 of the V-shaped element and the V-shaped element is positioned such that the pin 68 is inserted through the first member aperture 64 and remains thereinto in the unlocked position, which secures the longitudinal position of the biasing element 70 inside the second member passageway 60. This type of telescopic handle is well-known in the art and is used, for example, in telescopic handles for luggage.

In some embodiments of the invention, as shown in FIG. 9, the wrench head attachment portion 34 includes a wrench head attachment portion first segment 72 and a wrench head attachment portion second segment 74 extending from the wrench head attachment portion first segment 72. The wrench head attachment portion first and second segments 72 and 74 are angled relatively to each other, for example at an angle of about 45 degrees. This angle facilitates positioning of the proposed wrench 10 to relatively easily remove lug nuts of car wheels.

Although the present invention has been described hereinabove by way of preferred embodiments thereof, it can be modified, without departing from the spirit and nature of the subject invention as defined in the appended claims.

What is claimed is:

1. A wrench, said wrench being usable with a screwdriver head, said screwdriver head defining a screwdriver head effective portion and a screwdriver head attachment portion, said wrench comprising:
a substantially elongated telescopic handle, said telescopic handle defining a handle first end and a substantially longitudinally opposed handle second end, said telescopic handle being configurable between a retracted configuration and an extended configuration, said handle first and second ends being closer to each other in said retracted configuration than in said extended configuration;
said telescopic handle defining a handle first recess extending substantially longitudinally into said telescopic handle from said handle first end towards said handle second end and a handle second recess extending substantially longitudinally into said telescopic handle from said handle second end towards said handle first end, said handle first recess being configured and sized for slidably receiving said screwdriver head attachment portion thereinto; and
a wrench head, said wrench head defining a wrench head effective portion and a wrench head attachment portion, said wrench head attachment portion being slidable into said handle second recess.

2. A wrench as defined in claim 1, further comprising a screwdriver head lock for selectively locking said screwdriver head into said handle first recess.

3. A wrench as defined in claim 2, wherein said screwdriver head includes a screwdriver head locking aperture, said screwdriver head lock including
a screwdriver head lock aperture extending substantially radially inwardly into said telescopic handle, said screwdriver head lock aperture being located such that said screwdriver head locking aperture is positionable substantially in register with said screwdriver head lock aperture; and
a screwdriver head lock pin, said screwdriver head lock pin being slidably insertable through said screwdriver head locking aperture and through said screwdriver head lock aperture when said screwdriver head locking aperture and said screwdriver head lock aperture are substantially in register with each other.

4. A wrench as defined in claim 1, further comprising a wrench head lock for selectively locking said wrench head into said handle second recess.

5. A wrench as defined in claim 4, wherein said wrench head attachment portion defines a wrench head locking aperture, said wrench head lock including
a wrench head lock aperture extending substantially radially inwardly into said telescopic handle, said wrench head lock aperture being located such that said wrench head locking aperture is positionable substantially in register with said wrench head lock aperture; and
a wrench head lock pin, said wrench head lock pin being slidably insertable through said wrench head locking aperture and through said wrench head lock aperture when said wrench head locking aperture and said wrench head lock aperture are substantially in register with each other.

6. A wrench as defined in claim 1, wherein said telescopic handle has a substantially square cross-sectional configuration.

7. A wrench as defined in claim 6, wherein said telescopic handle includes a handle lock for selectively locking said telescopic handle in said extended configuration.

8. A wrench as defined in claim 7, wherein said telescopic handle includes
a handle first member, said handle first member having a substantially tubular configuration and defining a first member passageway; and
a handle second member slidably mounted into said first member passageway.

9. A wrench as defined in claim 8, wherein said handle lock includes:
a first member aperture extending substantially radially through said handle first member;
a second member aperture extending substantially radially through said handle second member, said handle first and second member being located configured and sized so that said first and second member apertures are substantially in register with each other when said telescopic handle is in said extended configuration; and
a pin mounted to said handle first and second member so as to be slidably movable through said first and second member apertures when said first and second member apertures are substantially in register with each other, said pin being movable between a locked position in which said pin extends through both said first and second member apertures and an unlocked position in which said pin engages at most one of said first and second member apertures.

10. A wrench as defined in claim 9, further comprising a biasing element operatively coupled to said pin for biasing said pin towards said locked position.

11. A wrench as defined in claim 9, wherein said telescopic handle includes at least three members operatively coupled to each other so as to be longitudinally slidable relatively to each other.

12. A wrench as defined in claim 1, wherein said wrench head attachment portion includes a wrench head attachment portion first segment and a wrench head attachment portion second segment extending from said wrench head attachment portion first segment, said wrench head attachment portion first and second segments being angled relatively to each other.
